(19) United States
(12) Patent Application Publication
(10) Pub. No.: US 2012/0014718 A1
(43) Pub. Date: Jan. 19, 2012

(54) DEVELOPING DEVICE, IMAGE FORMING APPARATUS, AND IMAGE FORMING METHOD

(75) Inventor: Takashi Ikeda, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/178,617

(22) Filed: Jul. 8, 2011

Related U.S. Application Data
(60) Provisional application No. 61/364,538, filed on Jul. 15, 2010.

(51) Int. Cl. G03G 15/08

(52) U.S. Cl. 399/253; 399/254; 399/255

(57) ABSTRACT

According to one embodiment, a developing device includes: a developing roller configured to supply a developer to a photoconductive drum; a first mixer configured to mix a fresh toner supplied from a toner supply section and the developer; a second mixer configured to supply the developer mixed by the first mixer to the developing roller; and a magnet roller including a magnet on an inside thereof and configured to remove foreign matters from the developer collected.

### CROSS-REFERENCE TO RELATED APPLICATIONS

This application is based upon and claims the benefit of priority from the prior the U.S. Patent Application No. 61/364538, filed on Jul. 15, 2010, and the entire contents of which are incorporated herein by reference.

### FIELD

Embodiments described herein relate generally to a developing device, an image forming apparatus, and an image forming method.

### BACKGROUND

An electronic image forming apparatus such as a printer or a copying machine supplies, with a developing device, a developer to an electrostatic latent image on a photoconductive drum and generates a developer image. The image forming apparatus transfers the developer image onto a recording medium and heats and presses the recording medium having the developer image transferred thereon to fix the developer image on the recording medium.

The developing device collects the developer supplied to the photoconductive drum, mixes the developer with a mixer, and reuses the developer.

In a process of the reuse of the developer, foreign matters such as paper powder could be mixed in the developer. The paper powder mixed in the developer deteriorates the quality of image formation.

To solve this problem, for example, a technique for filtering a developer with a mesh member and a technique for electrostatically attracting and removing foreign matters are proposed.

However, the mesh member cannot remove foreign matters smaller than meshes in size. When the foreign matters are electrostatically attracted, even a usable toner is electrostatically attracted.

Therefore, there is a demand for a developing device that can efficiently remove foreign matters from a developer.

In the related art, three mixers are necessary in order to sufficiently charge a recycle developer.

As a result, the number of components increases to cause an increase in manufacturing cost.

Therefore, there is a demand for a developing device including a smaller number of mixers.

### BRIEF DESCRIPTION OF THE DRAWINGS

FIG. 1 is a diagram of the configuration of an image forming apparatus;

FIG. 2 is an enlarged sectional view of a developing device;

FIG. 3A is a plan view of the developing device;

FIG. 3B is a plan view of the developing device according to an application example in which a magnet roller is detached from the developing device;

FIG. 4A is a side view of the magnet roller;

FIG. 4B is a side view of the magnet roller according to the application example;

FIG. 5A is a perspective view of the developing device from which the magnet roller is detached;

FIG. 5B is a perspective view of the developing device according to a first application example from which the magnet roller is detached;

FIG. 5C is a perspective view of the developing device according to a second application example from which the magnet roller is detached; and

FIG. 6 is a block diagram of the configuration of the image forming apparatus.

### DETAILED DESCRIPTION

Throughout this description, the embodiments and examples shown should be considered as exemplars, rather than limitations on the apparatus and methods of the present embodiments.

A developing device, an image forming apparatus, and an image forming method according to an embodiment are explained in detail below with reference to the accompanying drawings. Examples of the image forming apparatus include a copying machine, an MFP (Multifunction Peripheral), and a printer.

The image forming apparatus according to this embodiment includes an image bearing member, a developing roller configured to supply a developer to the image bearing member, a first mixer configured to mix a fresh toner and the developer, a second mixer configured to supply the developer mixed by the first mixer to the developing roller, and a magnet roller including a magnet on the inside thereof and configured to stand the developer with the magnet to thereby remove foreign matters from the developer collected.

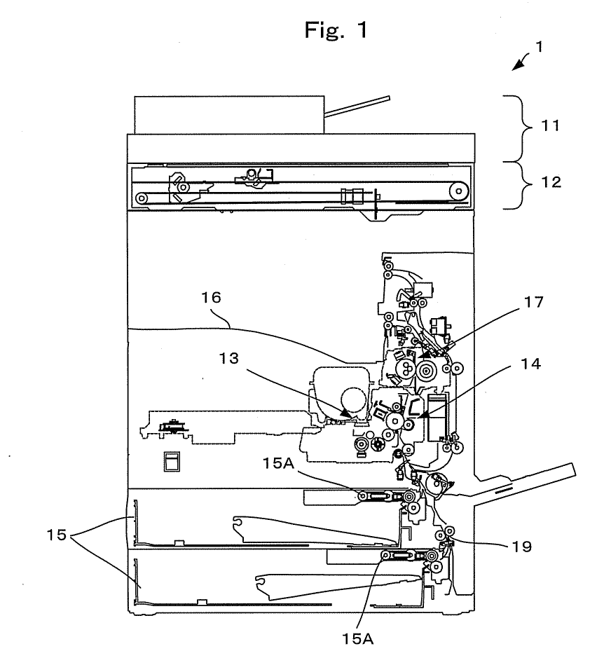

FIG. 1 is a diagram of the configuration of an image forming apparatus 1 according to this embodiment. As shown in FIG. 1, the image forming apparatus 1 includes an auto document feeder 11, an image reading section 12, an image forming section 13, a transfer section 14, a recording-medium conveying mechanism 19, and a paper feeding unit 15.

The image forming apparatus 1 includes an auto document feeder 11 in an upper part of a main body to be capable of opening and closing. The auto document feeder 11 includes a document conveying mechanism configured to pick up original documents from a paper feeding tray one by one and convey the original document to a paper discharge tray.

The auto document feeder 11 conveys the original documents to a document reading section of the image reading section 12 one by one with the document conveying mechanism. It is also possible to open the auto document feeder 11 and place an original document on a document table of the image reading section 12.

The image reading section 12 includes a carriage including an exposure lamp configured to expose an original document to light and a first reflection mirror, plural second reflection mirrors configured to move according to the movement of the carriage, a lens block, and a CCD (Charge Coupled Device) of an image reading sensor.

The carriage stands still in the document reading section or reciprocatingly moves under the document table to reflect the light of the exposure lamp, which is reflected by the original document, to the first reflection mirror. The plural second reflection mirrors reflect reflected light from the first reflection mirror to the lens block. The lens block outputs the reflected light to the CCD. The CCD converts incident light into an electric signal and outputs the incident light to the image forming section 13 as an image signal.

In the image forming apparatus 1 that can perform only monochrome printing, the image forming section 13 includes, concerning black K, a laser irradiating unit, a photoconductive drum 31, which is an image bearing member, and a developing device 21.

The laser irradiating unit, which is an electrostatic-latent image forming section, irradiates a laser beam on the photoconductive drum 31 on the basis of the image signal and forms an electrostatic latent image on the photoconductive drum 31. The developing device 21 supplies the developer to the photoconductive drum 31 and forms a developer image from the electrostatic latent image.

The recording-medium conveying mechanism 19 includes, most upstream on the paper feeding unit 15 side, a pickup mechanism 15A configured to pick up recording media one by one.

The pickup mechanism 15A picks up the recording media from the paper feeding unit 15 one by one and passes the recording medium to the recording-medium conveying mechanism 19. The recording-medium conveying mechanism 19 conveys the recording medium to the transfer section 14.

The transfer section 14 includes a transfer roller. The transfer roller applies a voltage to the developer image on the photoconductive drum 31 to transfer the developer image onto the recording medium conveyed to the transfer section 14.

The image forming apparatus 1 includes a fixing device 17 downstream in a recording medium conveying direction of the transfer section 14. The image forming apparatus 1 conveys the recording medium having the developer image transferred thereon to the fixing device 17. The fixing device 17 heats and presses the developer image to fix the developer image on the recording medium.

The recording medium discharged from a discharge port is stacked on a paper discharge tray 16, which is a carrying section configured to carry the recording medium.

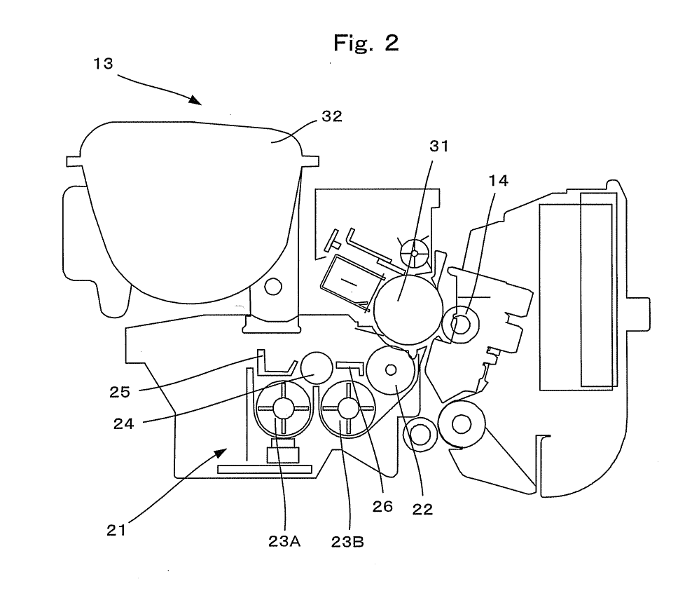

FIG. 2 is an enlarged sectional view of the developing device 21. As shown in FIG. 2, the developing device 21 includes a developing roller 22 configured to supply a developer to the photoconductive drum 31, a first mixer 23A configured to mix a fresh toner supplied from a toner supply section 32 and the developer, a second mixer 23B configured to supply the developer mixed by the first mixer 23A to the developing roller 22, a magnet roller 24 including a magnet on the inside thereof and configured to remove foreign matters from the developer collected, a regulating plate 26 configured to charge the developer on the magnet roller 24, and a collection box 25 configured to accumulate the foreign matters collected.

The developing roller 22 includes a magnet on the inside thereof and attracts the developer with the magnetism of the magnet to supply the developer to the photoconductive drum 31.

The second mixer 23B mixes a part of the mixed developer and the collected developer.

The magnet roller 24 is provided above the first mixer 23A and the second mixer 23B and between the first mixer 23A and the second mixer 23B.

The regulating plate 26 is arranged above the second mixer 23B and between the second mixer 23B and the magnet roller 24 to be spaced apart from the magnet roller 24.

The collection box 25 is provided downstream in a rotating direction of the magnet roller 24 with respect to the regulating plate 26 and has an opening opened upward.

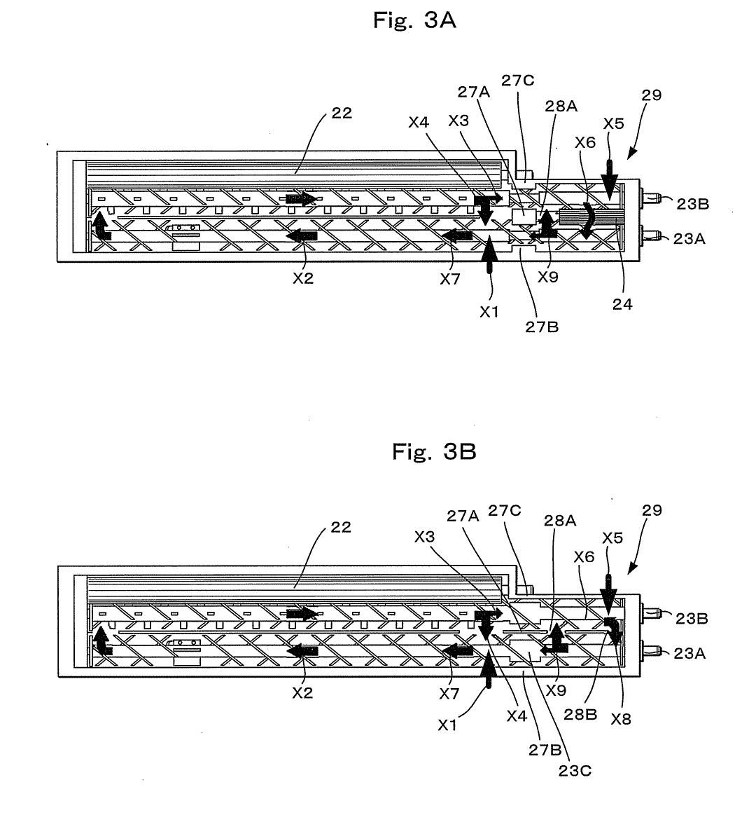

FIG. 3A is a plan view of the developing device 21. FIG. 3B is a plan view of the developing device 21 according to an application example in which the magnet roller 24 is detached from the developing device 21.

As shown in FIGS. 3A and 3B, the developing device 21 includes, further on the outer side of one end of the developing roller 22, a sub-chamber 29 for mixing and charging the developer. Ends of the first mixer 23A and the second mixer 23B and the magnet roller 24 are housed on the inside of the sub-chamber 29 of the developing device 21.

The sub-chamber 29 of the developing device 21 includes, between a section where the magnet roller 24 is arranged and a section where the developing roller 22 is arranged, first partition walls 27A, 27B, and 27C for regulating a flow of the developer and includes a second partition wall 28 between the first mixer 23A and the second mixer 23B.

The second partition wall 28 includes a first through-hole 28A and a second through-hole 28B for circulating the developer into the sub-chamber 29.

The fresh toner is supplied to the first mixer 23A indicated by an arrow X1. The first mixer 23A carries the fresh toner and the developer in a direction of an arrow X2 while mixing the fresh toner and the developer.

The mixed developer is passed to the second mixer 23B and supplied to the developing roller 22 while being carried.

A part of the developer is carried in the direction of the magnet roller 24 indicated by an arrow X3 and the remainder is passed to the first mixer 23A as indicated by an arrow X4.

The toner collected after being supplied to the photoconductive drum 31 is supplied from a position indicated by an arrow X5. The second mixer 23B mixes the collected toner and the developer and supplies the collected toner and the developer to the magnet roller 24.

The magnet roller 24 rotates in a direction of an arrow X6, discharges the foreign matters to the collection box 25, and drops the developer, from which the foreign matters are discharged, to the first mixer 23A.

A part of the dropped developer circulates in the sub-chamber 29 through the through-hole 28A and the through-hole 28B. In the circulation, the developer is mixed by the first mixer 23A and the second mixer 23B and charged.

In the related art, three mixers are necessary in order to sufficiently charge the developer. In this embodiment, the developer can be sufficiently charged by providing the sub-chamber 29 in the developing device 21 and circulating the developer into the sub-chamber 29. Therefore, it is possible to reduce the number of mixers to two.

The first mixer 23A carries the developer received from the magnet roller 24 in a direction of an arrow X7 and mixes the developer with the fresh toner and the developer supplied from the direction of the arrow X4.

In the developing device 21 according to this embodiment shown in FIG. 3A, an amount of the developer flowing into the sub-chamber 29 is controlled by increasing the thickness of the first partition walls 27A, 27B, and 27C.

In the developing device 21 according to the application example shown in FIG. 3B, an amount of the developer flowing into the sub-chamber 29 is controlled by thick sections 23C where the diameter of shafts of the first mixer 23A and the second mixer 23B is increased.

It is also possible to control an inflow amount of the developer into the sub-chamber 29 by combining the increase in the thickness of the first partition walls 27A, 27B, and 27C and the increase in the diameter of the first mixer 23A and the second mixer 23B.

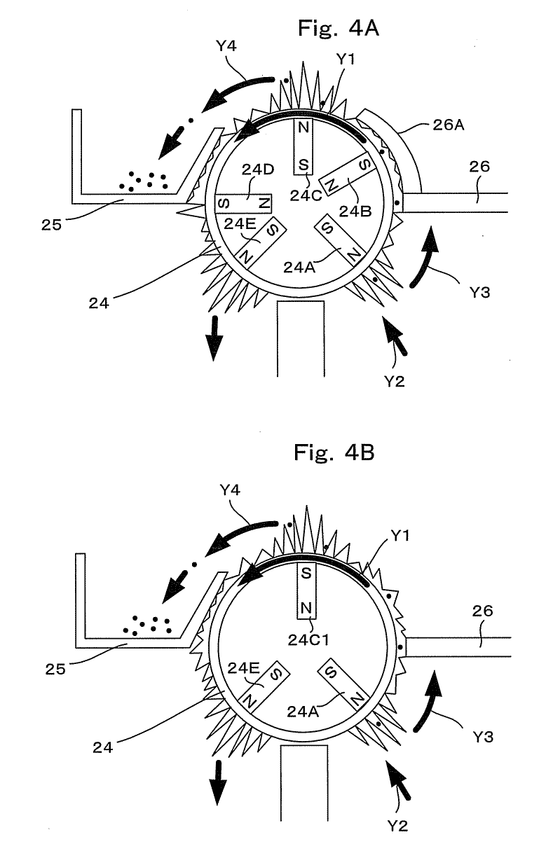

FIG. 4A is a side view of the magnet roller 24. As shown in FIG. 4A, the magnet roller 24 includes, on the inside thereof, along the rotating direction of the magnet roller 24, a gripping pole 24A, which is a magnet for attracting the developer from the second mixer 23B, a first carrying pole 24B, which is a magnet for carrying the developer attracted by the gripping pole 24A, a discharge pole 24C, which is a magnet for standing the developer and discharging the foreign matters, a second carrying pole 24D, which is a magnet for carrying the developer, and a peeling pole 24E, which is a magnet for peeling the developer.

As the polarities of the magnets, for example, the polarity of the gripping pole 24A is N, the polarity of the first carrying pole 24B is S, the polarity of the discharge pole 24C is N, the polarity of the second carrying pole 24D is S, and the polarity of the peeling pole 24E is N.

In this embodiment, in the developing device 21, a regulating plate 26A configured to regulate the developer from being stood by the first carrying pole 24B is provided in the regulating plate 26 along a downstream direction in the rotating direction of the magnet roller 24.

The magnet roller 24 rotates in a direction of an arrow Y1 and the magnet does not rotate. The gripping pole 24A attracts the developer in a direction of an arrow Y2. The developer contains foreign matters indicated by black dots.

The developer is carried in a direction of an arrow Y3 according to the rotation of the magnet roller 24. The developer is regulated by the regulating plate 26.

The developer is attracted to the magnet roller 24. When the developer is stood by magnetism in the discharge pole 24C, the foreign matters are discharged from the developer and fly out in a direction of an arrow Y4 with centrifugal force. The flown-out foreign matters are collected in the collection box 25.

The developer is further carried to the peeling pole 24E through the second carrying pole 24D. Since the polarities of the peeling pole 24E and the gripping pole 24A are the same, a magnetic field is cut and the developer is peeled off the magnet roller 24 and drops to the first mixer 23A.

FIG. 4B is a side view of the magnet roller 24 according to the application example. As shown in FIG. 4B, the magnet roller 24 includes, on the inside thereof, along the rotating direction of the magnet roller 24, the gripping pole 24A, which is a magnet for attracting the developer from the second mixer 23B, a discharge pole 24C1, which is a magnet for standing the developer and discharging the foreign matters, and the peeling pole 24E, which is a magnet for peeling the developer.

As to the polarities of the magnets, for example, the polarity of the gripping pole 24A is N, the polarity of the discharge pole 24C1 is S, and the polarity of the peeling pole 24E is N.

In this application example, the regulating plate 26A is unnecessary.

The magnet roller 24 rotates in the direction of the arrow Y1 and the magnet does not rotate. The gripping pole 24A attracts the developer in the direction of the arrow Y2. The developer contains foreign matters indicated by black dots.

The developer is carried in the direction of the arrow Y3 according to the rotation of the magnet roller 24. The developer is regulated by the regulating plate 26.

The developer is attracted to the magnet roller 24. When the developer is stood by magnetism in the discharge pole 24C1, the foreign matters are discharged from the developer and fly out in the direction of the arrow Y4 with centrifugal force. The flown-out foreign matters are collected in the collection box 25.

The developer is further carried to the peeling pole 24E. Since the polarities of the peeling pole 24E and the gripping pole 24A are the same, a magnetic field is cut and the developer is peeled off the magnet roller 24 and drops to the first mixer 23A.

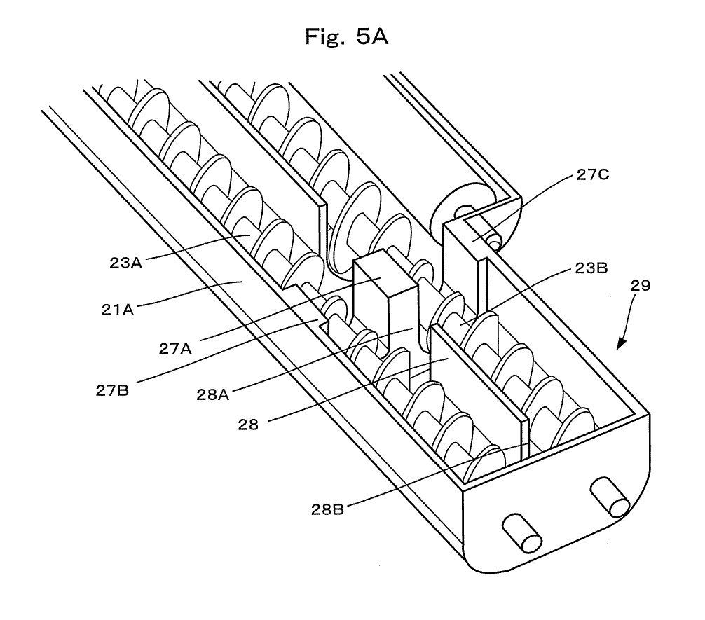

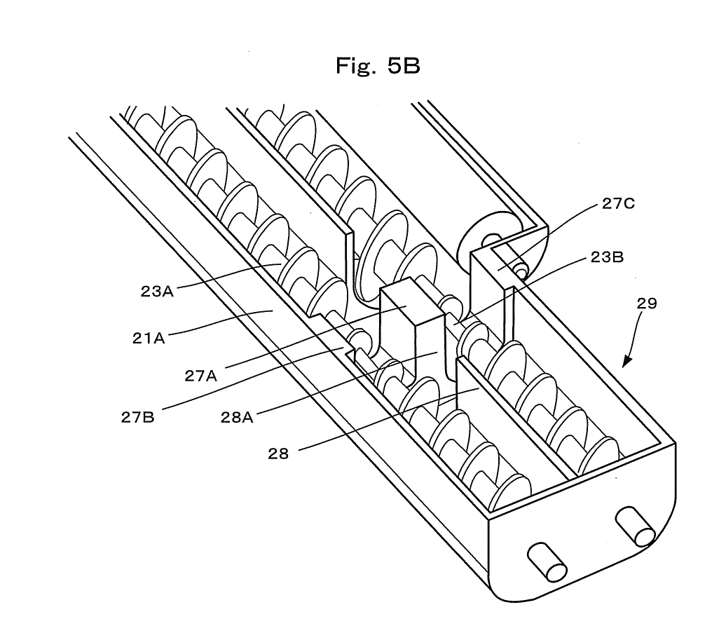

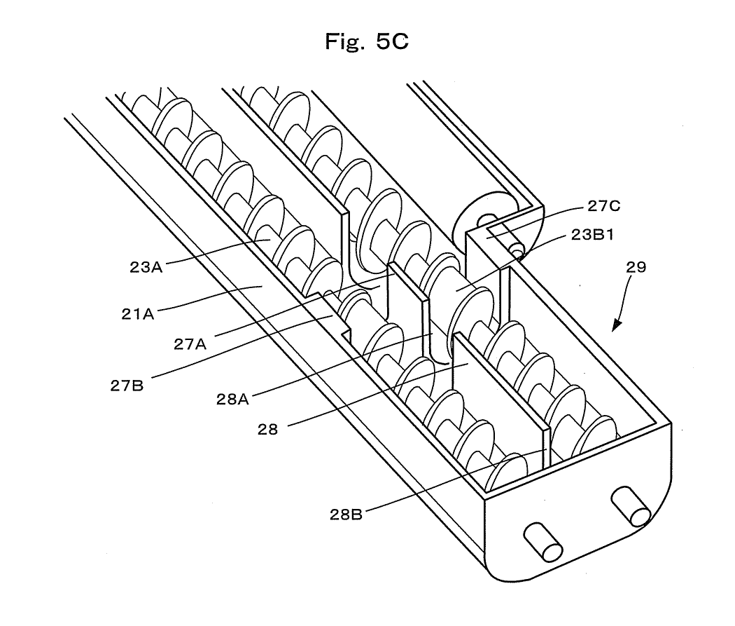

FIG. 5A is a perspective view of the developing device 21 from which the magnet roller 24 is detached. As shown in FIG. 5A, a housing 21A of the developing device 21 includes the first partition walls 27A, 27B, and 27C between a section where the magnet roller 24 is arranged and a section where the developing roller 22 is arranged and includes the second partition wall 28 between the first mixer 23A and the second mixer 23B.

In the developing device 21, a mixing ratio of the collected toner and the developer can be adjusted by adjusting the size of the first partition walls 27A, 27B, and 27C.

FIG. 5B is a perspective view of the developing device 21 according to a first application example from which the magnet roller 24 is detached. As shown in FIG. 5B, it is also possible to provide only the first through-hole 28A without providing the second through-hole 28B in the sub-chamber 29.

FIG. 5C is a perspective view of the developing device 21 according to a second application example from which the magnet roller 24 is detached. As shown in FIG. 5C, in the developing device 21, a developer inflow amount into the sub-chamber 29 and a developer outflow amount from the sub-chamber 29 can be adjusted by increasing or reducing the shaft diameter of the first mixer 23A and the second mixer 23B in the position of the first partition wall 27A.

In FIG. 5C, an example in which the thick sections 23C are provided by increasing the shaft diameter of the first mixer 23A and the second mixer 23B is shown.

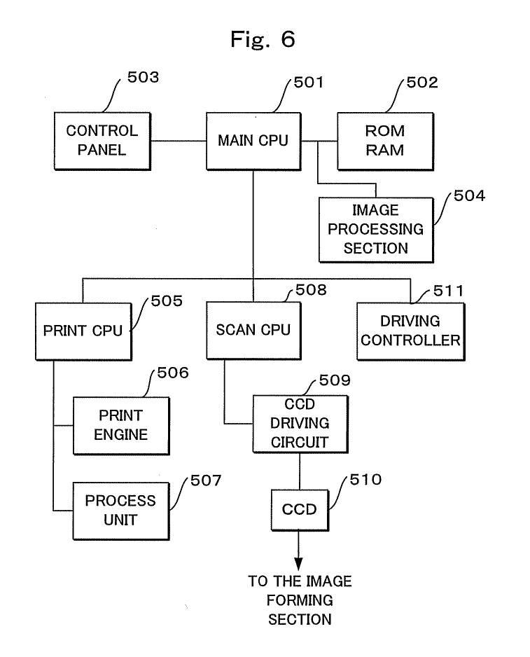

FIG. 6 is a block diagram of the configuration of the image forming apparatus 1. As shown in FIG. 6, the image forming apparatus 1 includes a main CPU 501, which is a control section, a control panel 503, which is a display input device, a ROM and RAM 502, which is a storage device, and an image processing section 504 configured to perform image processing.

The main CPU 501 is connected to and controls a print CPU 505, a scan CPU 508, and a driving controller 511 of the image forming apparatus 1.

The print CPU 505 is connected to and controls a print engine 506 configured to perform image formation and a process unit 507 including a transfer device.

The scan CPU 508 controls a CCD driving circuit 509 configured to drive a CCD 510. An output of the CCD 510 is output to the image forming section.

The driving controller 511 controls the recording-medium conveying mechanism 19.

As explained above, the developing device 21 according to this embodiment includes the developing roller 22 configured to supply the developer to the photoconductive drum 31, the first mixer 23A configured to mix the fresh toner supplied from the toner supply section 32 and the developer, the second mixer 23B configured to supply the developer mixed by the first mixer 23A to the developing roller 22, and the magnet roller 24 including the magnet on the inside thereof and configured to remove foreign matters from the collected developer.

Therefore, there is an effect that it is possible to efficiently remove the foreign matters from the developer.

The developing device 21 according to this embodiment includes, further on the outer side of one end of the developing roller 22, the sub-chamber configured to house the ends of the first mixer 23A and the second mixer 23B, partitioned by the first partition walls 27A, 27B, and 27C for regulating a flow of the developer, and including the second partition wall 28 having the through-holes 28A and 28B for circulating the developer between the first mixer 23A and the second mixer 23B.

Therefore, there is an effect that it is possible to sufficiently mix the developer in order to start charging of a recycle toner without increasing the number of mixers.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A developing device comprising:
a developing roller configured to supply a developer to an image bearing member;
a first mixer configured to mix a fresh toner and the developer;
a second mixer configured to supply the developer mixed by the mixer to the developing roller; and
a magnet roller including a magnet on an inside thereof and configured to, while rotating, stand the developer with the magnet to thereby remove foreign matters from the developer collected.

2. The developing device according to claim 1, wherein the magnet roller includes:
a gripping pole, which is a magnet for attracting the developer from the second mixer;
a discharge pole, which is a magnet for standing the developer and discharging the foreign matters; and
a peeling pole, which is a magnet for peeling the developer.

3. The developing device according to claim 2, wherein the magnet roller is provided above the first mixer and the second mixer and between the first mixer and the second mixer.

4. The developing device according to claim 3, further comprising a regulating plate arranged above the second mixer and between the second mixer and the magnet roller to be spaced apart from the magnet roller.

5. The developing device according to claim 4, wherein the second mixer mixes a part of the developer and the collected toner and supplies the mixed developer to the magnet roller.

6. The developing device according to claim 5, wherein a housing configured to house the first mixer and the second mixer includes a partition wall for adjusting a mixing ratio of the collected toner and the developer.

7. The developing device according to claim 6, further comprising a collection box provided downstream in a rotating direction of the magnet roller with respect to the regulating plate and having an opening opened upward.

8. An image forming apparatus comprising:
an image bearing member;
a developing roller configured to supply a developer to the image bearing member;
a first mixer configured to mix a fresh toner and the developer;
a second mixer configured to supply the developer mixed by the mixer to the developing roller; and
a magnet roller including a magnet on an inside thereof and configured to, while rotating, stand the developer with the magnet to thereby remove foreign matters from the developer collected.

9. The apparatus according to claim 8, wherein the magnet roller includes:
a gripping pole, which is a magnet for attracting the developer from the second mixer;
a discharge pole, which is a magnet for standing the developer and discharging the foreign matters; and
a peeling pole, which is a magnet for peeling the developer.

10. The apparatus according to claim 9, wherein the magnet roller is provided above the first mixer and the second mixer and between the first mixer and the second mixer.

11. The apparatus according to claim 10, further comprising a regulating plate arranged above the second mixer and between the second mixer and the magnet roller to be spaced apart from the magnet roller.

12. The apparatus according to claim 11, wherein the second mixer mixes a part of the developer and the collected toner and supplies the mixed developer to the magnet roller.

13. The apparatus according to claim 12, wherein a housing configured to house the first mixer and the second mixer includes a partition wall for adjusting a mixing ratio of the collected toner and the developer.

14. The apparatus according to claim 13, further comprising a collection box provided downstream in a rotating direction of the magnet roller with respect to the regulating plate and having an opening opened upward.

15. An image forming method comprising:
mixing a fresh toner and a developer;
mixing the mixed developer with a collected toner;
charging the collected toner and the mixed developer; and
standing the developer with a magnet of a rotating magnet roller, which includes the magnet on an inside thereof, to thereby remove foreign matters from the developer collected.

16. The method according to claim 15, further comprising:
attracting the developer from a second mixer with a gripping pole, which is a magnet arranged on the inside of the magnet roller;
standing the developer with a discharge pole, which is a magnet arranged on the inside of the magnet roller, to discharge foreign matters; and
peeling the developer with a peeling pole, which is a magnet arranged on the inside of the magnet roller.

17. The method according to claim 16, wherein the magnet roller is provided above the first mixer and the second mixer and between the first mixer and the second mixer.

18. The method according to claim 17, further comprising charging the developer with a regulating plate arranged above the second mixer and between the second mixer and the magnet roller to be spaced apart from the magnet roller.

19. The method according to claim 18, further comprising mixing a part of the developer and the collected toner and supplying the mixed developer to the magnet roller.

20. The method according to claim 19, further comprising adjusting a mixing ratio of the collected toner and the developer with a partition wall included in a housing configured to house the first mixer and the second mixer.

21. A developing device comprising:
a developing roller configured to supply a developer to an image bearing member;
a first mixer configured to mix a fresh toner and the developer;
a second mixer configured to supply the developer mixed by the first mixer to the developing roller; and
a sub-chamber provided further on an outer side of one end of the developing roller, configured to house ends of the first mixer and the second mixer, partitioned by a first partition wall for regulating a flow of the developer, and including a second partition wall having a through-hole for circulating the developer between the first mixer and the second mixer.

22. An image forming apparatus comprising:
an image bearing member;
a developing roller configured to supply a developer to the image bearing member;
a first mixer configured to mix a fresh toner and the developer;
a second mixer configured to supply the developer mixed by the first mixer to the developing roller; and
a sub-chamber provided further on an outer side of one end of the developing roller, configured to house ends of the first mixer and the second mixer, partitioned by a first partition wall for regulating a flow of the developer, and including a second partition wall having a through-hole for circulating the developer between the first mixer and the second mixer.
